(19) United States
(12) Patent Application Publication
(10) Pub. No.: US 2010/0169177 A1
(43) Pub. Date: Jul. 1, 2010

(54) METHOD AND SYSTEM FOR ASSESSING BEHAVIOR OF A WEBPAGE VISITOR

(76) Inventors: Virgil Griffith, Pasadena, CA (US); Aza Raskin, Pacifica, CA (US)

Correspondence Address: SCHOX PLC, 500 3rd Street, Suite 515, San Francisco, CA, 94107, US

(21) Appl. No.: 12/649,305

(22) Filed: Dec. 29, 2009

Related U.S. Application Data
(60) Provisional application No. 61/141,000, filed on Dec. 29, 2008.

(51) Int. Cl. G06F 15/173; G06F 17/00; G06Q 30/00; G06N 3/02; G06F 17/30

(52) U.S. Cl. 705/14.53; 709/224; 715/207; 705/14.66; 706/20; 707/776; 707/E17.014

(57) ABSTRACT

A method and system for assessing behavior of a webpage visitor includes providing a mining tool that is embedded within a webpage, sending a link list from a controlled server to a browser accessing a webpage, capturing visit-evaluations of the website links of the link list by the browser, and generating a browsing profile of a webpage visitor from the visit-evaluations of the website links of the link list.

### CROSS-REFERENCE TO RELATED APPLICATIONS

This application claims the benefit of US Provisional Application No. 61/141,000, filed on 29 Dec. 2008 and entitled “Method Of Deducing Demographic And Interests Of A Website Visitor”, which is incorporated in its entirety by this reference.

### TECHNICAL FIELD

This invention relates generally to the web browsing field, and more specifically to a new and useful method an system for assessing behavior of a webpage visitor in the web browsing field.

### BACKGROUND

Methods for determining if a visitor has viewed a particular webpage have been known since at least March 2006. Conventional methods only yield yes/no answers for whether a visitor has accessed a particular URL. However, complete browsing history of a visitor are still not accessible by a website. As another problem, websites and internet advertisers have little information concerning the visitors that view or interact with content. Knowing who clicks on advertisements, the demographics of website viewers, the interests of visitors, and other visitor-based information cannot be readily accessed by a website or internet advertiser. Some large websites (also known as “portals”) are able to gain a constrained view of a visitor, but even large website companies are limited to information provided by the visitor and the browsing history of webpages accessed within the large website company. This, however, provides no indication of what interests a viewer has outside of websites controlled by the company. Thus, there is a need in the web browsing field to create a new and useful method and system for assessing behavior of a webpage visitor. This invention provides such a new and useful method and system.

### BRIEF DESCRIPTION OF THE FIGURES

FIGS. 1 and 2 are flowchart representations of a method of a preferred embodiment of the invention;

FIG. 3 is a schematic representation of a system of preferred embodiment of the invention; and

FIGS. 4 and 5 are detailed representations of variations for implementing a visitor ID.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

Method of Assessing Behavior of a Webpage visitor

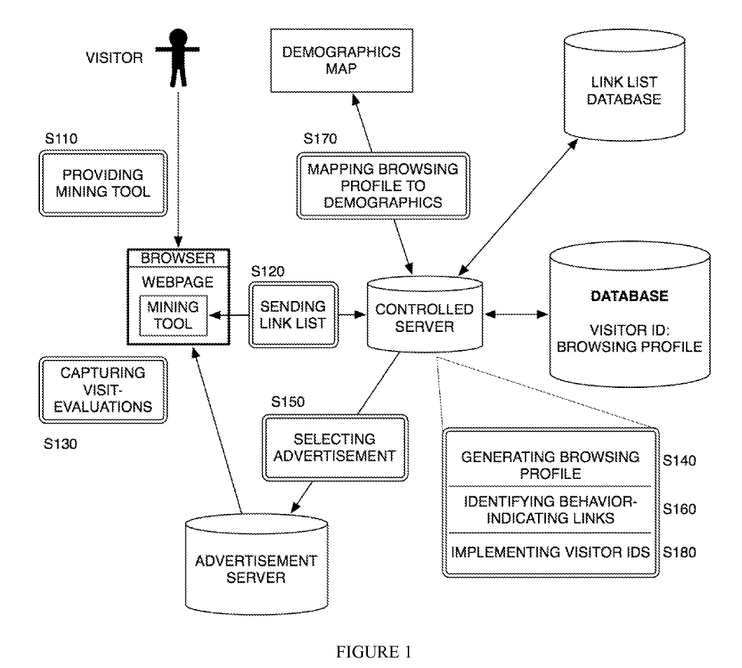

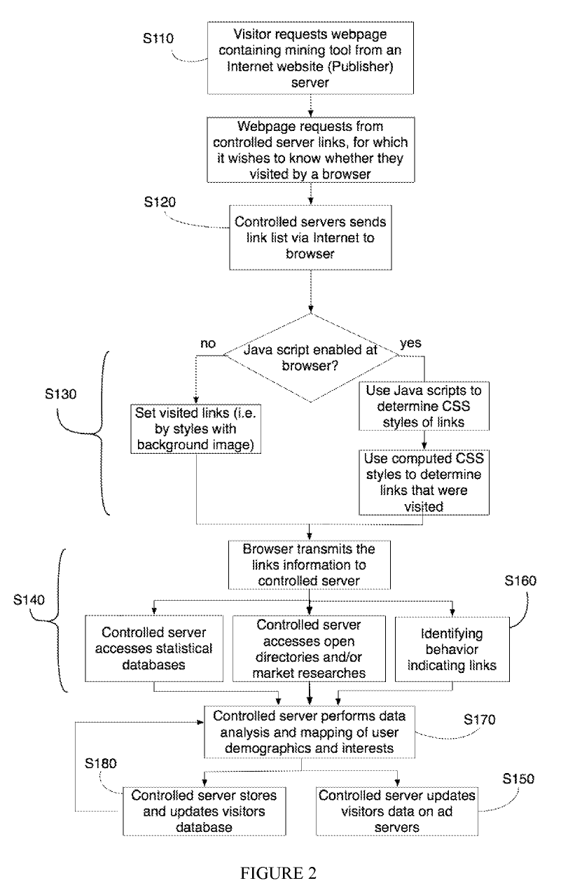

As shown in FIGS. 1 and 2, a method for assessing behavior of a webpage visitor of the preferred embodiment includes providing a mining tool for a website S110; sending a link list from a controlled server to a browser S120, capturing visit-evaluations of the links of the link list S130; and generating a browsing profile from the visit-evaluations S140. The method functions to use the visited link attribute of modern internet browsers to create a model of the visitor. The method may additionally be applied to determining the demographic information of a visitor, determining the demographic of people interacting with advertisements, delivering visitor targeted advertisements, and/or for any suitable application. The method preferably works with no prior knowledge of the visitor, but may additionally be expanded to create a visitor ID to monitor a visitor over a period of time. The method is preferably implemented over an internet network with communication occurring between a controlled server, a mining tool embedded in a webpage, and other data resources such as demographic maps, link list providers, and advertisement servers.

Step S110, which includes providing a mining tool for a website, functions to provide a way for a website to communicate with the controlled server to assess the browsing behavior of a webpage visitor. The mining tool is preferably an embeddable portion of code that a website administrator may include within the website. Online advertisers may alternatively include the mining tool within online advertising code. The mining tool is preferably an invisible portion of the website for the webpage visitor. The mining tool may alternatively be any suitable tool such as piece of software integrated with the browser, an application programming interface (API) for communicating with the controlled server, and/or any suitable device for a website to communicate with other devices implementing the method.

Step S120, which includes sending a link list from a controlled server to a browser, functions to provide a collection of website links used for deducing the visitor demographics, interests, identity, and/or any suitable aspect gathered from the browsing history of a visitor. A link list is preferably a collection of links, and the collection is preferably an exhaustive collection of a variety of links to different websites. In one example, the link list may include over 10,000 links. The link list preferably includes popular websites, and may additionally include popular websites of particular interests or sites that have a high correlation to particular demographic or visitor interest findings. In other words, a link of the link list may not be highly visited in comparison to other websites, but may have a high chance of being visited by people of a particular demographic or interest group. The link list may be created from open directories such as DMOZ.org or Delicious.com, statistical data sources such as Quantcast or Alexa, and/or any suitable source. In a variation where the method is performed iteratively or continuously during a website session, the link list may be created based on the results of the visit-evaluations of previous links of the link list. Additionally, by learning a visitor has visited a particular link, the controlled server or any suitable device can fetch the website of that link, parse the website for links, and send those links back to the browser to determine where within a website the visitor has visited. In other words, the server can spider the browsing history of a webpage visitor by providing a link list. The link list is preferably streamed or threaded from the controlled server to the browser using Ajax or any suitable asynchronous web-based communication model, which functions to allow the tasks of the mining tool to occur transparently for a webpage visitor. The links of the link list may additionally be compressed through known data compression methods, link shortening techniques (i.e., leaving off standard portions like “www.” or link shortners), and/or any suitable technique to reduce or minimize the amount of data sent to the browser.

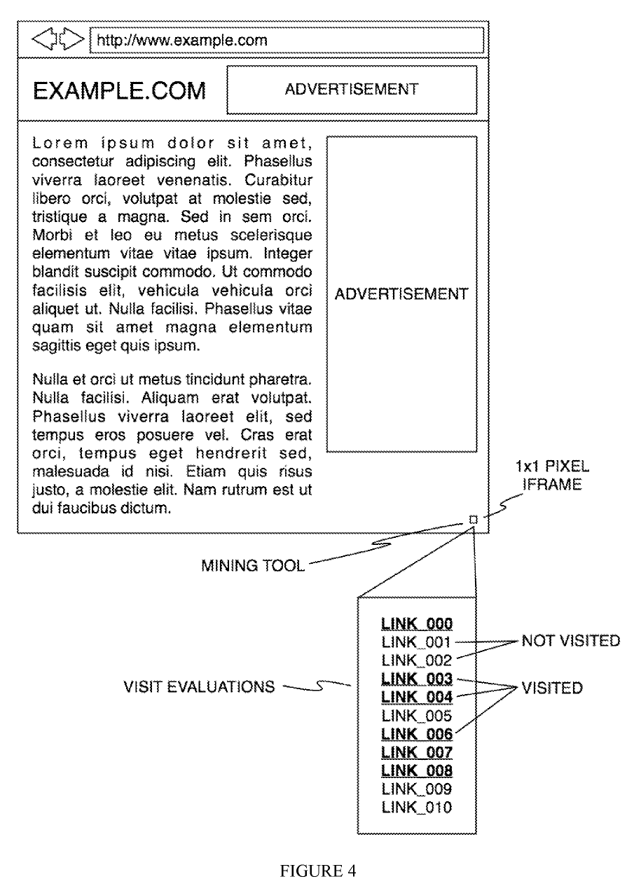

Step S130, which includes capturing visit-evaluations of the links of the link list, functions to determine if links of the link list have been visited based on browsing history of the browser. A visit-evaluation is preferably the differentiation a browser makes between a link that has been visited and a link that has not been visited. The visit-evaluation is preferably captured by the mining tool and sent to the controlled server. Capturing a visit evaluation preferably includes rendering a link within a browser, as shown in FIG. 4. To prevent the mining tool from effecting the display of the website, the links are preferably rendered in a non-visible portion of the webpage, such as within a substantially hidden iframe (e.g., non-visible or 1 pixel in size). The mining tool may alternatively have the links of the link list displayed in the browser behind an element (such as behind an advertisement), camouflage the links of the link list (e.g., same color as a background), or use any suitable way of having the links rendered by the browser. The visit-evaluation may be captured in any suitable manner. A first variation for capturing a visit-evaluation of a link includes evaluating the CSS style of a link of the link list and comparing the computed CSS style to a “visited link” style (e.g., a:visited) and “not visited link” style to determine if a link has been visited or not visited. This variation is preferably performed using JavaScript to analyze the CSS styling of a link. A second variation for capturing a visit-evaluation of a link includes styling the browser rending of a link with a unique media element hosted on the controlled server and recording when a unique media element is requested from the controlled server. The media element is preferably an image file used for a background of a link or alternatively a border element or any suitable media displayed with the link. This variation functions to allow a visit-evaluation of a browser to be captured when a browser has JavaScript disabled. The styling of the links of the link list is preferably sandboxed so that styles of the webpage will not conflict with the link list link style. Additionally, the capture of visit-evaluations may include creating at least a second link list with website links based on a website that a visit-evaluation indicates has been visited and capturing visit-evaluations of at least the second link list.

Step S140, which includes generating a browsing profile from the visit-evaluations, functions to create a representation of the browsing history of a webpage visitor. The browsing profile is preferably related to the sites the webpage visitor has visited, and may additionally include information such as interests, data corresponding to affinity for a website (e.g., deduced by amount/depth of exploration a visitor has performed on a particular site), and/or any other suitable aspect. A browsing profile is preferably a representation for an individual webpage visitor (e.g., a visitor ID described below), a categorization of a set of users (e.g., a visitor demographic categorization as described below), a representation suitable for individual identification and user categorization, or any suitable representation. Data from captured visit-evaluations may additionally be added to a profile such that a browsing history of a visitor may be built up over visits to different websites and/or at different times.

Additionally, the method of the preferred embodiment may include selecting an advertisement for webpage use based on the browser profile of a visitor S150, which functions to use the browsing history of a webpage visitor to customize advertising. The data from the browser profile may be used in a variety of ways. For example, advertisements are preferably displayed that correspond to the browsing habits of a webpage visitor.

As another addition, the method of the preferred embodiment may include identifying a behavior-indicating link S160, which functions to predict or interpret actions of a webpage visitor. A behavior-indicating link is preferably any website from which context or behavior of a visitor may be deduced. Behavior-indicating links are preferably identified by scraping the page for information and identifying interface features, text, or any suitable website features indicative of a particular behavior related website page. A behavior-indicating link may be a login page link, a purchase page link, a signup page link, or any suitable page from which significance may be extracted. Login pages, purchase pages, and signup pages typically have design paradigms that would allow a page scraper to identify the type of page through techniques such as data scraping. For example, login pages would have a text field for a username and a password text field, and there may be a link to a “join” or “create an account” website. Depending on the combination of the visit-evaluations of different behavior-indicating links various behaviors or actions may be deduced, such as if a webpage visitor made a purchase, decided to not purchase, signed up, logged in, forgot password. For example, identifying a purchase page behavior-indicating link as visited indicates that a visitor made a purchase from a webpage. As a counter-example, identifying a behavior-indicating link as not being visited would indicate that a visitor did not make or complete a purchase from a webpage. Step S160 may be used cooperatively with Step S150 for selecting an advertisement based on behavior-indicating links. This may be used to send advertisements to a webpage when the behavior of a visitor would indicate that the visitor is susceptible to a type of advertisement. For example, if a visitor visited a website but never completed a signup process or purchase, an advertisement may be selected which would encourage the visitor to follow through with the signup process or purchase (e.g., either on the same site or at a competitor site). Additionally advertisements may be excluded from webpage use based on an identified behavior-indicating link. This negative advertisement susceptibility correlation would function to prevent advertising when the past behavior of a visitor would indicate the advertisement would not be effective. An advertisement would not be used when behavior of a visitor would indicate the visitor would be less susceptible to that particular advertisement. For example, if a visitor purchased a new car (as indicated by visited behavior-indicating link) an advertisement for buying a car would not be sent to the visitor. In this situation, a more appropriate advertisement might include car insurance or car modifications (such as better speakers or gun racks).

Additionally, the method of the preferred embodiment may include mapping the browsing profile to a visitor demographic S170. Step S170 functions to link visitor history data obtained through targeted browser history to the known aggregate demographics for those sites so that the demographics of the visitor can be deduced. The browsing profile (or the received visit-evaluations) is preferably used to calculate the probable demographic group and/or set of interests of the webpage visitor. The browsing profile is preferably used cooperatively along with a database of mappings of demographic information to websites to algorithmically predict the demographic information of a visitor. In a variation where the browsing profile is formatted as a demographic descriptor, the browsing profile is preferably updated with captured visit-evaluations when mapping the browsing profile to a visitor demographic. The database mappings may come from open directories like DMOZ.org, Delicious.com and/or any suitable market researches and statistical data may be accessed from such sources as Quantcast and Alexa. For example, a visitor is known to visit site X and site Y, where X has a 60% male readership and Y has a 55% male readership. One way to calculate the probability that the visitor is male is to compute 1/(1+0.4/0.6*0.45/0.55)=0.647, or 64.7%. Another way to calculate the probability is by direct averaging, so that (60+55)/2=57.5% probably of being male. Additionally or alternatively, the browser-profile can be used to build a view of the interests of the visitor. This database correlates visitors with their interests, represented by the visited websites (e.g., Expedia represents travel, flights, hotels, etc.), and statistical analyses can determine the top interests of the visitor. The mapping of the browsing profile to a visitor demographic preferably uses neural networking with a demographic website data, but any suitable method may be used. The demographic information may be used in a variety of applications. In one embodiment the demographic information is provided to a webpage operator which functions to provide more detailed information about visitors to a webpage. A webpage operator may use the information for tracking applications, webpage customization, or any suitable purpose. In a second embodiment the demographic information is provided to advertisers which functions to give advertisers better incite into who is interacting or not interacting with advertisements. Preferably, the visitor demographic is recorded each time an advertisement is clicked or interacted with in the case of video, audio, or interactive based advertisements.

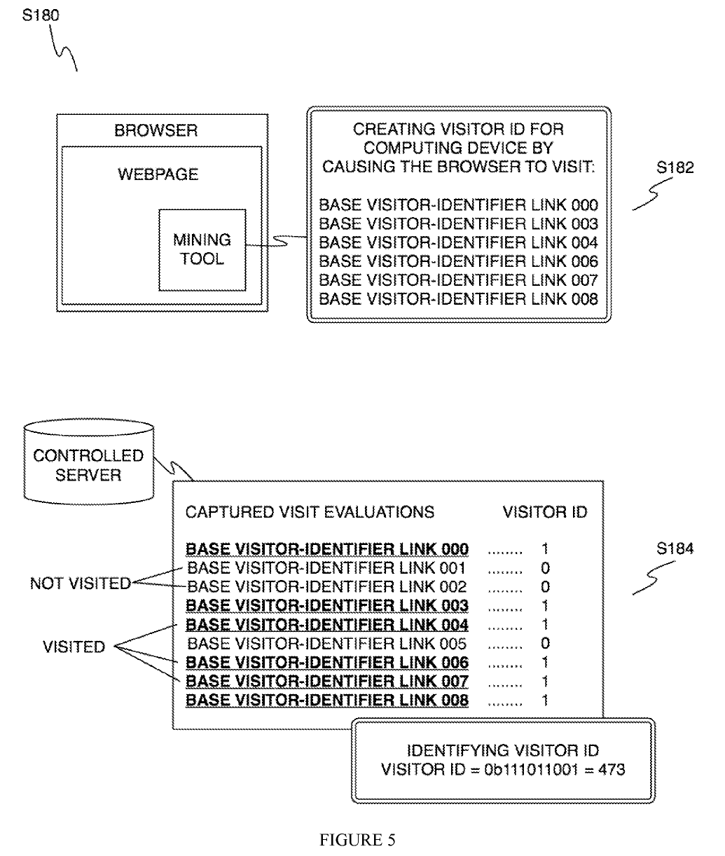

Additionally the method of the preferred embodiment may include implementing visitor IDs S180 which functions to create a way of tracking a visitor across different websites and over periods of time. In this variation the browser profile preferably functions as a visitor ID that can uniquely identify a website visitor. Implementing visitor IDs preferably includes creating a visitor ID that associates a computing device with a browser profile of a webpage visitor S182 and identifying a visitor ID through a mining tool S184. Step S180 may additionally include updating the browser profile associated with the visitor ID using the visit-evaluations of the links of the link list. Step S182 preferably includes providing at least one visitor identifier link. The mining tool preferably causes the browser to view the visitor identifier link such that later the visit-evaluation of the link by the browser would indicate the link has been viewed (despite the fact that the visitor never actually navigated nor saw the page associated with the link). The visitor-identifier link is preferably added to the link list. The visitor ID may be deduced from the visit-evaluation of visitor-identifier links. Visitor-identifier links are preferably checked first when visiting a webpage with a mining tool. If no visitor identifier is identified then the mining tool causes the browser to view a visitor identifier link. In one variation, a unique visitor-identifier link will be created to identify a visitor. Additionally a plurality of base visitor-identifier links may be used to encode the visitor ID, as shown in FIG. 5. In this variation, each visitor identifier link preferably represents a single bit of a visitor ID. A unique visitor ID is preferably created by causing the browser to view a unique combination of the base visitor-identifier links. Once a visitor ID is established on a computing device, the visitor ID is preferably retrieved by capturing the visit-evaluations for the full plurality of base visitor-identifier links. Only the visitor-identifier links that the mining tool forced the browser to have viewed would show up as viewed and the visitor ID would be known. This variation functions to allow fewer visitor-identifier links to be checked. Alternatively any suitable method may be used to identify a visitor such as a cookie, pattern matching of current browser profile with stored browser profiles, and/or any suitable method.

### System for Assessing Behavior of a Webpage Visitor

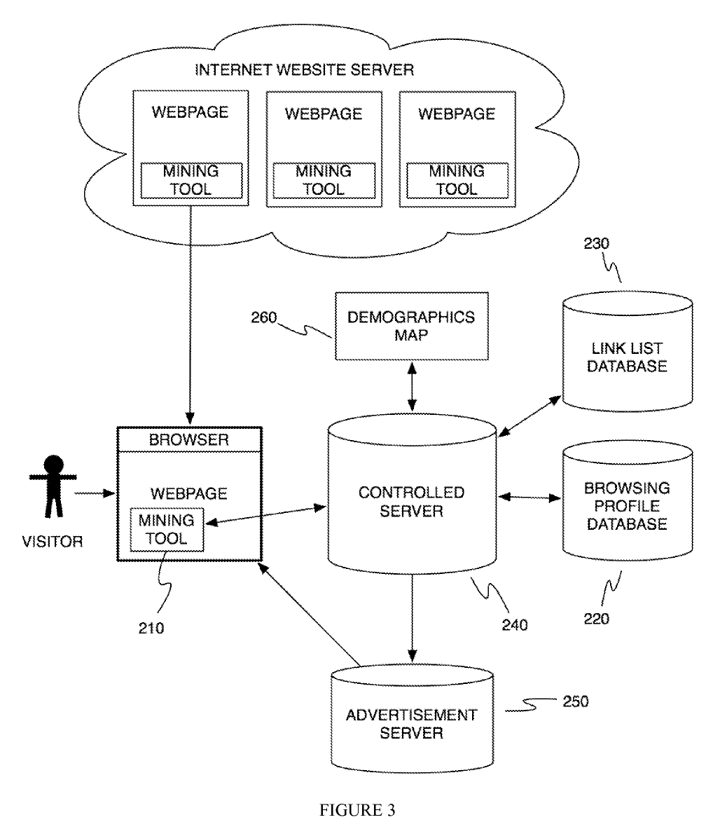

As shown in FIG. 3, the system for assessing behavior of a webpage visitor of the preferred embodiment includes a link list database 210, a mining tool 220, a browsing profile database 230, and a controlled server 240. The system functions to allow the capture of visitor browsing history and to provide websites and/or advertisers with visitor information. The system primarily functions to implement the method described above for assessing behavior of a webpage visitor, but may function to implement similar methods.

The link list database 210 of the preferred embodiment functions to provide a collection of links to the mining tool. The links contained within the link list are preferably a comprehensive sampling of links generated based on probable webpages a visitor may have visited. When initially encountering a webpage visitor (having no knowledge of the visitor) the links are preferably a general list designed to obtain basic understanding of the links that the webpage visitor has viewed. The links of the link list may be created from open directories such as DMOZ.org or Delicious.com, statistical data sources such as Quantcast or Alexa, and/or any suitable source. After some knowledge has been obtained concerning a webpage visitor more specific or targeted links are preferably added to the link list. For example, links that have been visited by the webpage visitor (as indicated by captured visit-evaluations) are preferably scraped and have the links contained within the webpage added to the link list to investigate where within a webpage the visitor has been. This functions to essentially crawl a visitors browsing history. Alternatively or additionally, sites that are similar to visited links or any link relating to visited links may be added to the link list.

The mining tool 220 of the preferred embodiment functions to communicate information from a browser to the controlled server 240. The mining tool 220 is preferably embeddable within a webpage and captures the browser rendering of visited or not-visited links. The mining tool 220 preferably has a communication connection to the controlled server 240 to receive a link list, receive advertisements, send visit-evaluations and/or perform any suitable task. The mining tool 220 may be part of an embeddable advertisement or may be a separate piece of embeddable code.

The browsing profile database 230 of the preferred embodiment functions as a collection of browsing profiles created by the controlled server 240. The browsing profile database 230 is preferably organized by visitor IDs which are assigned to individual browsers. When a browser is identified by a visitor ID, the respective browsing profile can be accessed and updated by the mining tool 210 and controlled server 240. The browsing profile database 230 may alternatively be organized by user categorization or include user categorization. The visit-evaluations collected by the mining tool 220 preferably determine the demographic of the browsing profile of a particular browser. The browsing profile database 230 may alternatively or additionally be used as statistical data for assessing visitor browsing patterns.

The controlled server 240 of the preferred embodiment functions to coordinate the processing and dataflow between the browser and outside datasources. The controlled server 240 is preferably in communication with the mining tool 210 as a way of gathering information from the browser, but may additionally or alternatively communicate with the browser through an API. The controlled server 240 additionally has communication connections with the link list database 220, browsing profile database 230, advertising server(s) 250, demographic maps 260, and/or any suitable component.

The system of the preferred embodiment preferably includes an advertising server 250, which functions to provide advertisements to the webpage that hosts the mining tool. The advertisements are preferably selected based on the browsing history, visitor behavior, demographic information, and/or any suitable aspect. The advertising server 250 may alternatively be a control program that communicates with third party advertisement servers.

The system of the preferred embodiment preferably includes a demographic map 260, which functions as a guide for determining visitor information. The demographic map 260 is preferably a representation of statistically probable visitor demographics, visitor interests, other visited webpages, and/or any predictable aspect of a visitor based on browsing history. The demographic map 250 is preferably used with a neural network in determining the demographics of a visitor from a browsing profile of a webpage visitor.

As part of the preferred embodiment or as an alternative embodiment, the system may implement the above methods in a computer-readable medium storing computer-readable instructions. The instructions are preferably executed by computer-executable components for assessing behavior of a webpage visitor. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device. An embeddable portion of computer readable medium preferably resides within the code of a webpage and communicates with an outside portion of the computer readable medium through an internet connection.

As a person skilled in the art will recognize from the previous detailed description and from the figures and claims, modifications and changes can be made to the preferred embodiments of the invention without departing from the scope of this invention defined in the following claims.

We claim:

1. A method for assessing behavior of a webpage visitor comprising:
providing a mining tool that is embedded within a webpage;
sending a link list from a controlled server to a browser accessing a webpage, the webpage containing the embedded mining tool, wherein the link list contains website links;
capturing visit-evaluations of the website links of the link list by the browser, wherein the visit-evaluation of a link indicates if a link has been visited or not visited based on browser history; and
generating a browsing profile of a webpage visitor from the visit-evaluations of the website links of the link list.

2. The method of claim 1, wherein capturing visit-evaluations includes rendering a website link of the link list within a non-visible portion of the webpage.

3. The method of claim 2, wherein capturing visit-evaluations includes:
evaluating the CSS style of a website link of the link list; and
comparing the CSS style to visited link and not visited link CSS styles to determine if a website link has been visited or not visited.

4. The method of claim 2, wherein capturing visit-evaluations includes:
styling the browser rendering of a website link with a unique media element hosted on the controlled server; and
recording when the unique media element is requested from the controlled server to determine if a website link has been visited or not visited.

5. The method of claim 1, wherein capturing visit-evaluations further includes creating a second link list with website links based on a website that a visit-evaluation indicates has been visited and capturing visit-evaluations of the second link list.

6. The method of claim 1, further comprising mapping the browsing profile to a visitor demographic and providing demographic information of the webpage visitor to the website.

7. The method of claim 6, wherein the mapping of the browsing profile to a visitor demographic uses a neural networking with a demographic website data.

8. The method of claim 1, further comprising selecting an advertisement for webpage use based on the browser profile of the visitor.

9. The method of claim 8, further comprising identifying visited behavior-indicating links.

10. The method of claim 9, wherein behavior-indicating links includes: login page website links, purchase page website links, and signup page website links.

11. The method of claim 9, wherein an advertisement is selected based on behavior-indicating links.

12. The method of claim 9, further comprising excluding an advertisement from webpage use based on identified behavior-indicating links.

13. The method of claim 8, further comprising mapping the browser profile to a visitor demographic and tracking the visitor demographic for an advertisement used on a webpage that receives visitor interaction.

14. The method of claim 1, further comprising:
creating a visitor ID that associates a computing device with a browser profile of a webpage visitor;
identifying a visitor ID through the mining tool; and
wherein generating a browsing profile of a webpage visitor includes updating the browser profile associated with the visitor ID using the visit-evaluations of the website links of the link list.

15. The method of claim 14, wherein identifying a visitor ID through the mining tool includes providing at least one visitor-identifier link that the mining tool causes the browser to visit; adding the at least one visitor-identifier link to the link list;
and determining a visitor ID based on the visit-evaluation of the visitor-identifier link.

16. The method of claim 15, wherein the mining tool causes the browser to visit a unique combination of a plurality of visitor-identifier links; and wherein determining a visitor ID is based on a unique combination of visit-evaluations of a plurality of visitor-identifier links.

17. The method of claim 1, wherein sending a link list from a controlled server is streamed to the browser as compressed data.

18. A system for assessing behavior of a webpage visitor comprising:
a link list database that is a sampling of links;
a mining tool embeddable within a webpage that captures the browser rendering of visited or not-visited links;
a browsing profile database that is updated according to data collected by the mining tool; and
a controlled server that manages communication between mining tool, link list, and browsing profile database.

19. The system of claim 18, further comprising an advertisement server that provides advertisements to a webpage according to a browsing profile.

20. The system of claim 19, further comprising a demographic map that contains statistical correlations of the demographic of visitors to webpages, and is used by the controlled server to calculate a demographic of a visitor from a browsing profile.
